(19) United States
(12) Patent Application Publication
(10) Pub. No.: US 2016/0021376 A1
(43) Pub. Date: Jan. 21, 2016

(54) MEASUREMENT OF VIDEO QUALITY

(71) Applicant: The British Academy of Film and Television Arts, London (GB)

(72) Inventors: Ioannis Andreopoulos, London (GB); Pamela D. Fisher, London (GB); Nikolaos Deligiannis, London (GB); Vasileios Giotsas, London (GB)

(21) Appl. No.: 14/801,693

(22) Filed: Jul. 16, 2015

(30) Foreign Application Priority Data
Jul. 17, 2014 (GR) 20140100386
Aug. 20, 2014 (GB) 1414795.3

(51) Int. Cl. H04N 19/154; G06T 7/00; H04N 17/04; H04N 19/86; H04N 17/00; H04N 17/02

(52) U.S. Cl. CPC H04N 19/154; H04N 17/004; H04N 17/02; H04N 17/04; H04N 19/86; G06T 7/0002; G06T 7/0085; G06T 2207/30168; G06T 2207/10016

(57) ABSTRACT

In a method of generating a measure of video quality, a set of weightings (160) for a plurality of objective quality metrics is obtained. The objective quality metrics have themselves been calculated from a plurality of measurable objective properties (120) of video data files (100). The weightings (160) have been determined by fitting the objective quality metrics to a set comprising a ground-truth quality rating of each of the video data files coming from human scoring of quality (100). The method includes receiving a target video data file (180), the quality of which is to be measured. Values are calculated for the objective quality metrics (220) on the target video data file (180). The measure of video quality (240) is generated by combining the values for the objective quality metrics (220) on the target video data file (180) using the obtained set of weightings (160).

### FIELD OF THE INVENTION

The present invention concerns measurement of video quality. More particularly, but not exclusively, this invention concerns a method of generating a measure of video quality, an apparatus for generating a measure of video quality and a computer program product for generating a measure of video quality.

### BACKGROUND OF THE INVENTION

In recent years, there has been a meteoric rise of Internet-delivered video, with over 50% of Internet traffic being video. That has resulted in the creation of encoding tools and services, content delivery networks (CDNs), media hosting services, open source toolsets, and both general-purpose ICT products and services, and domain-specific systems & markets (e.g. broadcast encoders, edit systems).

Media industry stakeholders are deeply concerned with the visual quality of video presented to audiences, as can be seen, for example, in the migration to digital cinema (⅔rds of global cinema is now digital), where content creators control viewing quality manually. The drive for improved video quality can also be seen from advances in standards for video coding (e.g. HEVC/H.265), network delivery (e.g. MPEG-DASH), and colour technology (e.g., Rec.2020 UHDTV, ACES, OpenColorIO), with the main aim to achieve high-impact visual quality and service differentiation throughout the media pipeline. There is a clear connection between video quality and user behaviour (e.g. stream abandonment, fast forward, skip). Research relating to changes in engagement due to visual quality reports a viewing drop-off when there is loss in quality. Several trends confirm the growing importance of visual quality, including: growth in long-form video viewing as a proportion of all online video; increasing ‘lean back’ viewing on smart/connected TVs; and rising connection speeds, with the average UK broadband connection now supporting multiple video streams at once.

Furthermore, professional media content creators and owners have many options to choose between for digital distribution of their video. Those options include: self-publishing (e.g. on YouTube or Vimeo); licensing deals with IPTV aggregators, broadcasters and OTT (‘Over the Top’) TV services; and direct distribution to users. Frequently, several of those options are chosen, so that one video title can be found on several platforms. Almost all services maintain their own encoding pipelines. A service will procure a “contribution quality” instance of the video data file and then encode it to their target specifications. Material is re-encoded infrequently, if at all. However, the interests of the distributors and content owners are at odds: on the one hand, content owners want their titles to be displayed in as high a quality as possible, and to remain current as formats, networks and coding standards evolve; on the other hand, distributors and aggregators want to have complete control of their supply chain, and achieve consistency across all assets, regardless of incoming quality.

There is therefore a general desire to improve and control quality of video particularly when provided across a data network. Some visual quality improvement for streamed video can be achieved solely through improvement in the associated data networks, such as a reduction in network latency.

Processing can be carried out on video data files, for example when storing or distributing the video. Processing operations, for example encoding, transcoding and video streaming over IP or wireless networks, are often “lossy”, with video information being removed from the file in order to achieve a desirable result, for example a reduction in the volume of the video data file. It can be hard to predict how a human viewer will perceive the effects of lossy processing when the processed data file is played. In order to assess the effects, human subjects are asked to rate the quality of the video in a controlled test, providing a subjective “perceptual quality” rating. Specifically, each subject is asked to assign a score to the reference or undistorted video and a score to the distorted, processed version. The difference between those scores is calculated and mean- and variance-based normalization of those “difference scores” is carried out. The normalized difference scores are then scaled to the range 0 to 100 and, after outlier rejection, averaged over all human subjects that rated the particular video, providing a “difference mean opinion score” (DMOS) for the video (see for example Seshadrinathan, K. and Soundararajan, R. and Bovik, A. C. and Cormack, L. K., “Study of subjective and objective quality assessment of video”, IEEE Trans. Image Process. (2010), 1427-1441). The video DMOS is also referred to as “ground truth” quality rating or “ground truth” quality score for the video. There exist test video databases, with a plurality of videos stored together with the DMOS for each video. The standard deviation of the normalized-and-scaled difference scores for each video is also kept to indicate the divergence of opinions of human subjects for the particular video content.

Several visual quality metrics have been developed to enable perceptual video quality to be estimated by a computer without the need for carrying out tests using groups of human subjects. The accuracy of a visual quality metric is quantified by its statistical correlation with the DMOS of each video within test video databases. One can categorise the metrics in three tiers, of increasing utilization of basic objective properties extracted from the video sequences.

The first category includes metrics that are scaled versions of objective distortion criteria, for example a scaled version of a logarithm of the inverse L1 or L2 distortion between frames of two videos under consideration. Example well-known metrics that we categorise in this tier are:
the peak signal-to-noise ratio (PSNR); and
the structural similarity index metric (SSIM)(see, for example Sheikh, H. R. and Sabir, M. F. and Bovik, A. C., “A statistical evaluation of recent full reference image quality assessment algorithms”, IEEE Trans. Image Process. (2006), 3440-3451).

The second tier of visual quality metrics involves extraction of spatial features from images via frequency-selective and/or spatially-localized filters, either in a single scale (spatial resolution) or in multiple scales (multi-resolution). Example well-known metrics that we categorise in this tier are:
Multiscale-SSIM (MS-SSIM—Wang, Z. and Simoncelli, E. P. and Bovik, A. C., “Multiscale structural similarity for image quality assessment” (2003), 1398-1402.).): this is an extension of the SSIM paradigm for still images. It has been shown to outperform the SSIM index and many other still-image quality-assessment algorithms. Similar to PSNR and SSIM, the MS-SSIM index is extended to video by applying it frame-by-frame on the luminance component of each video frame and computing the overall MS-SSIM index for the video as the average of the frame-level quality scores.
Visual Information Fidelity (VIF—Sheikh, H. R. and Sabir, M. F. and Bovik, A. C., “A statistical evaluation of recent full reference image quality assessment algorithms”, IEEE Trans. Image Process. (2006), 3440-3451): this is an image information measure that quantifies the information that is present in the reference (unprocessed) image and how much of that reference information can be extracted from the distorted image.
P-HVS (PSNR—Human Visual System, Egiazarian, K. and Astola, J. and Ponomarenko, N. and Lukin, V. and Battisti, F. and Carli, M., “New full-reference quality metrics based on HVS” (2006)) and P-HVSM (Ponomarenko, N. and Silvestri, F. and Egiazarian, K. and Carli, M. and Astola, J. and Lukin, V., “On between-coefficient contrast masking of DCT basis functions” (2007)): these are two weighted versions of PSNR that take into account contrast sensitivity in the pixel and discrete cosine transform domain, respectively.

The third tier includes objective quality metrics that include features extracted based on spatial and temporal properties of the video sequence, i.e., both intra-frame and inter-frame properties. Example well-known metrics that we categorise in this tier are:
MOtion-based Video Integrity Evaluation (MOVIE—Seshadrinathan, K. and Bovik, A. C., “Motion tuned spatio-temporal quality assessment of natural videos”, IEEE Trans. Image Process. (2010), 335-350.) index in its temporal, spatial and aggregate forms, a.k.a. T-MOVIE, S-MOVIE and MOVIE: these perform an optical flow estimation and a Gabor spatial decomposition in order to extract temporal and spatial quality indices against a reference video.
Video Quality Model (VQM—Pinson, M. H. and Wolf, S., “A new standardized method for objectively measuring video quality”, IEEE Trans. Broadcast. (2004), 312-322.): this is a video quality assessment algorithm adopted by ANSI and ITU-T as a standard metric for visual quality assessment. VQM performs spatio-temporal calibration in the input video and then extracts perception-based features (based on spatio-temporal activity detection in short video segments) and computes and combines together video quality parameters to produce a single metric for visual quality.

Previous work has focused on comparisons of such metrics on publicly-available databases of original and distorted video content, for example the LIVE (Seshadrinathan, K. and Soundararajan, R. and Bovik, A. C. and Cormack, L. K., “Study of subjective and objective quality assessment of video”, IEEE Trans. Image Process. (2010), 1427-1441.) and the EPFL-PoliMi (Seshadrinathan, K. and Bovik, A. C., “Motion tuned spatio-temporal quality assessment of natural videos”, IEEE Trans. Image Process. (2010), 335-350.) databases. Those two databases contain video files having a mixture of four different distortion types: MPEG-2 compression, H.264 compression, and simulated transmission of H.264 compressed bitstreams firstly through error-prone IP networks and secondly through error-prone wireless networks. They are becoming the de-facto standard for perceptual video quality assessment as they circumvent certain issues with Video Quality Experts Group (VQEG) studies, namely their use of outdated or interlaced content, their poor perceptual separation of videos and the fact that the videos were not made publicly available.

Perceptual quality estimation of still images has been carried out by machine learning using feature vectors (for example, color, 2D cepstrum, weighted pixel differencing, spatial decomposition coefficients).

WO 2012012914 A1 (Thomson Broadband R&D (Beijing) Co. Ltd.) describes a method and corresponding apparatus for measuring the quality of a video sequence. The video sequence is comprised of a plurality of frames, among which one or more consecutive frames are lost. During the displaying of the video sequence, said one or more lost frames are substituted by an immediate preceding frame in the video sequence during a period from the displaying of said immediate preceding frame to that of an immediate subsequent frame of said one or more lost frames. The method comprises: measuring the quality of the video sequence as a function of a first parameter relating to the stability of said immediate preceding frame during said period, a second parameter relating to the continuity between said immediate preceding frame and said immediate subsequent frame, and a third parameter relating to the coherent motions of the video sequence.

In WO 2011134110 A1 (Thomson Licensing) a method and apparatus for measuring video quality using a semi-supervised learning system for mean observer score prediction is proposed. The semi-supervised learning system comprises at least one semi-supervised learning regressor. The method comprises training the learning system and retraining the trained learning system using a selection of test data wherein the test data is used for determining at least one mean observer score prediction using the trained learning system and the selection is indicated by a feedback received through a user interface upon presenting, in the user interface, said at least one mean observer score prediction. This method is semi-supervised.

US 20130266125 A1 (Dunne et al./IBM) describes a method, computer program product, and system for a quality-of-service history database. Quality-of-service information associated with a first participant in a first electronic call is determined. The quality-of-service information is stored in a quality-of-service history database. A likelihood of quality-of-service issues associated with a second electronic call is determined, wherein determining the likelihood of quality-of-service issues includes mining the quality-of-service history database. The provided Quality-of-service information of this invention does not provide any explicit means of estimating the quality of video.

The present invention seeks to provide an improved measurement of video quality.

### SUMMARY OF THE INVENTION

A first aspect of the invention provides a method of generating a measure of video quality, the method comprising:
(a) providing a plurality of video data files and corresponding ground-truth quality ratings expressing the opinions of human observers;
(b) measuring a plurality of objective properties of each of the video data files;
(c) calculating for each of the video data files a plurality of objective quality metrics from the plurality of measured objective properties;
(d) obtaining a set of weightings for the plurality of objective quality metrics by fitting the plurality of objective quality metrics to the corresponding ground-truth quality rating for each of the plurality of video data files;
(e) receiving a target video data file, the quality of which is to be measured;
(f) measuring the plurality of objective properties of the target video data file;
(g) calculating for the target video data file values for the plurality of objective quality metrics from the plurality of measured objective properties; and
(h) generating the measure of video quality by combining the values for the objective quality metrics for the target video data file using the obtained set of weightings.

A second aspect of the invention provides computer program product configured to, when run, generate a measure of video quality, by carrying out the steps:
(a) obtaining a set of weightings for a plurality of objective quality metrics, the objective quality metrics having themselves been calculated from a plurality of measurable objective properties of video data, the weightings having been determined by fitting the objective quality metrics to a set comprising a ground-truth quality rating of each of a plurality of video data files;
(b) receiving a target video data file, the quality of which is to be measured;
(c) calculating values for the objective quality metrics on the target video data file;
(d) generating the measure of video quality by combining the values for the objective quality metrics on the target video data file using the obtained set of weightings.

A third aspect of the invention provides a computer program product configured, when run, to carry out the method of the first aspect of the invention.

A fourth aspect of the invention provides a computer apparatus for generating a measure of video quality, the apparatus comprising:
(a) a memory containing a set of weightings for a plurality of objective quality metrics calculated from a plurality of measurable objective properties of video data;
(b) an interface for receiving a target video data file;
(c) a processor configured to (i) calculate values for the objective quality metrics on a received target video data file, (ii) retrieve the set of weightings from the memory and (iii) generate the measure of video quality by combining the values for the objective quality metrics on the received target video data file using the retrieved set of weightings.

A fifth aspect of the invention provides a computer apparatus for generating a measure of video quality, the apparatus comprising:
(a) a database containing a plurality of video data files and corresponding quality ratings;
(b) an interface for receiving a target video data file;
(c) a processor configured to:
   i. measure a plurality of objective properties of each of the video data files in the database;
   ii. calculate for each of the video data files in the database a plurality of objective quality metrics from the plurality of measured objective properties;
   iii. obtain a set of weightings for the plurality of objective quality metrics by fitting the plurality of objective quality metrics to the corresponding quality rating for each of the plurality of video data files in the database;
   iv. measure the plurality of objective properties of a received target video data file;
   v. calculate for the received target video data file values for the plurality of objective quality metrics from the plurality of measured objective properties;
   vi. generate the measure of video quality by combining the values for the objective quality metrics for the received target video data file using the obtained set of weightings.

A sixth aspect of the invention provides a method of generating a measure of video quality, the method comprising:
(a) obtaining a set of weightings for a plurality of objective quality metrics, the objective quality metrics having themselves been calculated from a plurality of measurable objective properties of video data, the weightings having been determined by fitting the objective quality metrics to a set comprising a quality rating of each of a plurality of video data files;
(b) receiving a target video data file, the quality of which is to be measured;
(c) calculating values for the objective quality metrics on the target video data file;
(d) generating the measure of video quality by combining the values for the objective quality metrics on the target video data file using the obtained set of weightings.

It will of course be appreciated that features described herein in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying drawings.

FIG. 1 is a schematic diagram showing components of a computer apparatus according to a first example embodiment of the invention.

FIG. 2 is a flowchart showing steps in an example method of operating the apparatus of FIG. 1.

FIG. 3 is a plot of ground-truth DMOS values for videos (sorted by mean DMOS) in the (a) LIVE database and (b) EPFL database. For each video, the x marks plot the ground-truth DMOS value (i.e. the DMOS value recorded in the database) and the open circles plot the DMOS estimated by an example method according to the invention, using OLS regression (bars indicate the standard deviations of the ground-truth DMOS values).

FIG. 4 is a plot of ground-truth DMOS values for videos (sorted by mean DMOS) in the (a) LIVE database and (b) EPFL database. For each video, the x marks plot the ground-truth DMOS value and the open circles plot the DMOS estimated by (a) the VM metric and (b) the S-MOVIE metric (bars indicate the standard deviations of the DMOS values).

### DETAILED DESCRIPTION

A first aspect of the invention provides a method of generating a measure of video quality, the method comprising:
(a) providing a plurality of video data files and corresponding ground-truth quality ratings expressing the opinions of human observers;
(b) measuring a plurality of objective properties of each of the video data files;
(c) calculating for each of the video data files a plurality of objective quality metrics from the plurality of measured objective properties;
(d) obtaining a set of weightings for the plurality of objective quality metrics by fitting the plurality of objective quality metrics to the corresponding ground-truth quality rating for each of the plurality of video data files;
(e) receiving a target video data file, the quality of which is to be measured;
(f) measuring the plurality of objective properties of the target video data file;
(g) calculating for the target video data file values for the plurality of objective quality metrics from the plurality of measured objective properties; and
(h) generating the measure of video quality by combining the values for the objective quality metrics for the target video data file using the obtained set of weightings.
   As used herein “objective quality metric” is a measure of video quality that is calculated using objective properties of the video data file, for example using an algorithm that includes several processing steps. It is not a subjective assessment and, for example, does not use the measured opinions of human subjects. The objective properties of the video data file will be technical properties, for example contrast, degree of edge blur, or flicker, motion activity, mean-squared error between frames, mean-absolute error between frames and/or another error metric between frames. It may be that at least one of the objective quality metrics is calculated using at least two different objective properties of the video data file.

The generated measure of video quality is reproducible in that, once the weightings have been obtained for the plurality of data files, the measure will be deterministically producible for any given target video data file, every time it is generated.

“Ground truth quality ratings” are subjective ratings by human subjects. The quality ratings can be, for example, mean opinion scores (MOS), differential mean opinion scores (DMOS) or quantitative scaling derived from descriptive opinions of quality (e.g., a rating between 0-100 derived by aggregating comments such as “too blurry” or “many motion artefacts”, or the like). Preferably, the generated measure of video quality is within 15%, within 10%, within 5% or even within 1% of the ground truth quality rating.

The quality ratings can be normalised across the video data files. The quality ratings can be scaled across the video data files.

The quality ratings can be provided together with an indication of the distribution of quality rating for each video data file, for example the standard deviation of the quality ratings.

The objective quality metrics can be, for example, automated visual quality metrics or distortion metrics. The objective quality metrics include at least two different objective quality metrics. Preferably, the plurality of objective quality metrics includes at least 3 at least 5, at least 7, at least 10 or at least 15, at least 20, at least 30, or at least 50 objective quality metrics.

The objective quality metrics are calculated from the plurality of measured objective properties. The objective quality metrics can be metrics that are scaled versions of objective distortion criteria, for example scaled version of a logarithm of the inverse L1 or L2 distortion between a frame of the video data file and of a reference video data file. The objective quality metrics can be metrics that involve extraction of spatial features from images via frequency-selective and/or spatially-localized filters, either in a single scale (spatial resolution) or in multiple scales (multi-resolution). The objective quality metrics can be metrics that include features extracted based on spatial and temporal properties of the video sequence (that is, both intra-frame and inter-frame properties).

For example, the plurality of objective quality metrics can be selected from the following list: PSNR, SSIM, MS-SSIM, VIF, P-HVS, P-HVSM, S-MOVIE, T-MOVIE, MOVIE, VQM, and a combination of two or more of those metrics.

The method is implemented on a computer. For example, the method can be implemented on a server, a personal computer or on a distributed computing cluster (for example on a cloud computing system).

The target video data file can be a file streamed over a computer network.

The target video data file can be an extract from a longer video. For example, the target video data file can be an extract of video of 1 to 10 seconds duration. The method can include the step of identifying extracts from the video data file based on changes in a parameter (for example bitrate or an objective quality metric, e.g. PSNR or SSIM) with time.

The plurality of video data files provided with corresponding ground-truth can include the target video data file.

The method can be carried out in parallel on a plurality of successive extracts from the target video data file.

The fitting of the plurality of objective quality metrics to the corresponding quality rating for each of the plurality of video data files can be by linear or non-linear regression. The fitting of the plurality of objective quality metrics to the corresponding quality rating for each of the plurality of video data files can be based on classification algorithms.

The fitting of the plurality of objective quality metrics to the corresponding quality rating for each of the plurality of video data files can start from a random estimation of the weightings.

The fitting can be by adjusting the weightings to minimise a norm of the error between the objective quality metrics, combined according to the weightings, and the quality ratings for the plurality of video data files.

The norm can be the L₂ norm (i.e. the fit can be a least squares fit). The norm can be the L₁ norm. The norm can be the L-infinity norm.

The fitting can be by variational Bayesian linear regression.

The method can include the step of obtaining a revised set of weightings for the plurality of objective quality metrics by fitting the plurality of objective quality metrics to the corresponding quality rating for each of a different plurality of video data files. The different plurality of video data files may or may not overlap with the plurality of video data files used for obtaining the previous set of weightings.

The objective properties of the video data files can be data relating to, for example, texture or motion.

The method can further include the step of altering transcoding of the target video data file to alter (for example, to improve or to intentionally reduce) its visual quality according to the generated measure of visual quality. The method can include iteratively altering the encoding of the target video data file to optimise the generated measure of visual quality (for example to maximise it, to bring it to a target value or to otherwise improve it).

The method can include the step of automatically browsing the internet (for example using an “expert crawler” or “Internet bot”) to identify target video data files, generating the measures of video quality, and altering transcoding of the target video data files to alter their visual quality according to the generated measures of visual quality.

The method may include the step of generating the measure of video quality for playback of the target video file on a plurality of different end-user devices (e.g. mobile phones, tablets, HDTVs), thereby providing a device-specific characterization of video-quality loss.

The method may include the step of generating the measure of video quality for at least two target video files. The method can include the step of generating a measure of the relative video quality of the at least two target video files. The at least two target video files can be lower and higher quality transcodings of the same video, transmitted at lower and higher bitrates, respectively. The method can include the step of adjusting the bitrates to improve utilisation of bandwidth. The method can include the step of adjusting the bitrates to increase or decrease the difference in the generated measures of video quality for the lower and higher quality transcodings. The method can include combining the generation of the measure of video quality with a scene-cut detection algorithm.

Advantageously, example embodiments of the method can operate without human involvement in the steps described herein.

The method can further include the step of generating a Quality of Experience (QoE) rating for the video data file, the QoE rating being based on, on the one hand, the generated measure of visual quality and, on the other hand, network-level metrics and/or user-level metrics, for example network load, buffering ratio, join time, and/or the device upon which the video is to be viewed.

It may be that the target video data file is provided on the Internet, for example on a website. The method can further include the step of generating the measure of video quality for a further target video data file and using the generated measures of quality in determining whether one of the target video file and the further target video file is a copy of the other. The method can further comprise the step of issuing a take-down notice to the host of the target video data file.

A second aspect of the invention provides computer program product configured to, when run, generate a measure of video quality, by carrying out the steps:
(a) obtaining a set of weightings for a plurality of objective quality metrics, the objective quality metrics having themselves been calculated from a plurality of measurable objective properties of video data, the weightings having been determined by fitting the objective quality metrics to a set comprising a ground-truth quality rating of each of a plurality of video data files;
(b) receiving a target video data file, the quality of which is to be measured;
(c) calculating values for the objective quality metrics on the target video data file;
(d) generating the measure of video quality by combining the values for the objective quality metrics on the target video data file using the obtained set of weightings.

A third aspect of the invention provides a computer program product configured, when run, to carry out the method of the first aspect of the invention.

A fourth aspect of the invention provides a computer apparatus for generating a measure of video quality, the apparatus comprising:
(a) a memory containing a set of weightings for a plurality of objective quality metrics calculated from a plurality of measurable objective properties of video data;
(b) an interface for receiving a target video data file; and
(c) a processor configured to (i) calculate values for the objective quality metrics on a received target video data file, (ii) retrieve the set of weightings from the memory and (iii) generate the measure of video quality by combining the values for the objective quality metrics on the received target video data file using the retrieved set of weightings.

The weightings may have been determined by fitting the objective quality metrics to a set comprising a quality rating of each of a plurality of video data files.

The target video file may be provided by downloading or uploading the video data files, for example from one or more locations remote from the computer apparatus.

A fifth aspect of the invention provides a computer apparatus for generating a measure of video quality, the apparatus comprising:
(a) a database containing a plurality of video data files and corresponding quality ratings;
(b) an interface for receiving a target video data file;
(c) a processor configured to:
   i. measure a plurality of objective properties of each of the video data files in the database;
   ii. calculate for each of the video data files in the database a plurality of objective quality metrics from the plurality of measured objective properties;
   iii. obtain a set of weightings for the plurality of objective quality metrics by fitting the plurality of objective quality metrics to the corresponding quality rating for each of the plurality of video data files in the database;
   iv. measure the plurality of objective properties of a received target video data file;
   v. calculate for the received target video data file values for the plurality of objective quality metrics from the plurality of measured objective properties; and
   vi. generate the measure of video quality by combining the values for the objective quality metrics for the received target video data file using the obtained set of weightings.

The computer apparatus of the fourth or fifth aspects of the invention can be, for example, a server, a personal computer or a distributed computing system (for example a cloud computing system).

A sixth aspect of the invention provides a method of generating a measure of video quality, the method comprising:
(a) obtaining a set of weightings for a plurality of objective quality metrics, the objective quality metrics having themselves been calculated from a plurality of measurable objective properties of video data, the weightings having been determined by fitting the objective quality metrics to a set comprising a quality rating of each of a plurality of video data files;
(b) receiving a target video data file, the quality of which is to be measured;
(c) calculating values for the objective quality metrics on the target video data file; and
(d) generating the measure of video quality by combining the values for the objective quality metrics on the target video data file using the obtained set of weightings.

It may be that the set of weightings were obtained by (i) calculating values for the objective quality metrics using the video data files, the quality of each of the video data files having been been rated, and (ii) determining the set of weightings of the values of the objective quality metrics that fits a combination of the values to the quality ratings of the video data files.

It may be that the calculating values for the objective quality metrics using the video data files included measuring the plurality of measurable objective properties of the video data files.

Thus, the method can include the preliminary steps of (i) calculating values for the objective quality metrics using the video data files, the quality of each of the video data files having been rated, and (ii) determining the set of weightings of the values of the objective quality metrics that fits a combination of the values to the quality ratings of the video data files.

The method can include the preliminary step of measuring the plurality of measurable objective properties of the video data files.

A seventh aspect of the invention provides a method of generating a measure of video quality, the method including:
(a) providing a plurality of video data files and corresponding ground-truth quality ratings expressing the opinions of human observers;
(b) measuring a plurality of objective properties of each of the video data files;
(c) calculating for each of the video data files a plurality of objective quality metrics from the plurality of measured objective properties; and
(d) obtaining a set of weightings for the plurality of objective quality metrics by fitting the plurality of objective quality metrics to the corresponding ground-truth quality rating for each of the plurality of video data files;

In example embodiments of the method, automated scorings (or automated expert opinions) of perceptual quality of a video sequence are grouped and, via machine learning techniques, an aggregate metric is derived that can predict the mean (or differential mean) opinion score (MOS or DMOS, respectively) of human viewers of said video sequence.

The automated scorings (or automated expert opinions) for perceptual quality of a video sequence can comprise a plurality of existing visual quality metrics, for example peak signal-to-noise ratio, structural similarity index metric (SSIM), multiscale SSIM, MOVIE metrics, visual quality metric (VQM). The automated scorings can include other metrics relating to video quality.

The machine learning technique used to predict the MOS or DMOS of human viewers can be based on linear or non-linear regression and training with representative sequences with known MOS or DMOS values.

The machine learning technique used to predict the MOS or DMOS of human viewers can be based on classification algorithms, e.g., via support vector machines or similar, and training with representative sequences with known MOS or DMOS values.

The provided training set of MOS and DMOS values and associated videos can stem from an online video distribution service in a dynamic manner and retraining can take place.

Objective quality metrics can be regarded as being “myopic” expert systems, focussing on particular technical aspects of visual information in video, such as image edges or motion parameters. The inventors have realised that the combination of many such “myopic” metrics leads to significantly-improved prediction of perceptual video quality, compared with the prediction of each individual metric.

Further, example embodiments of the invention permit optimisation of video coding and perceptual quality, in contrast to some prior-art approaches, where the “visual quality improvement” is solely through reduction in network latency.

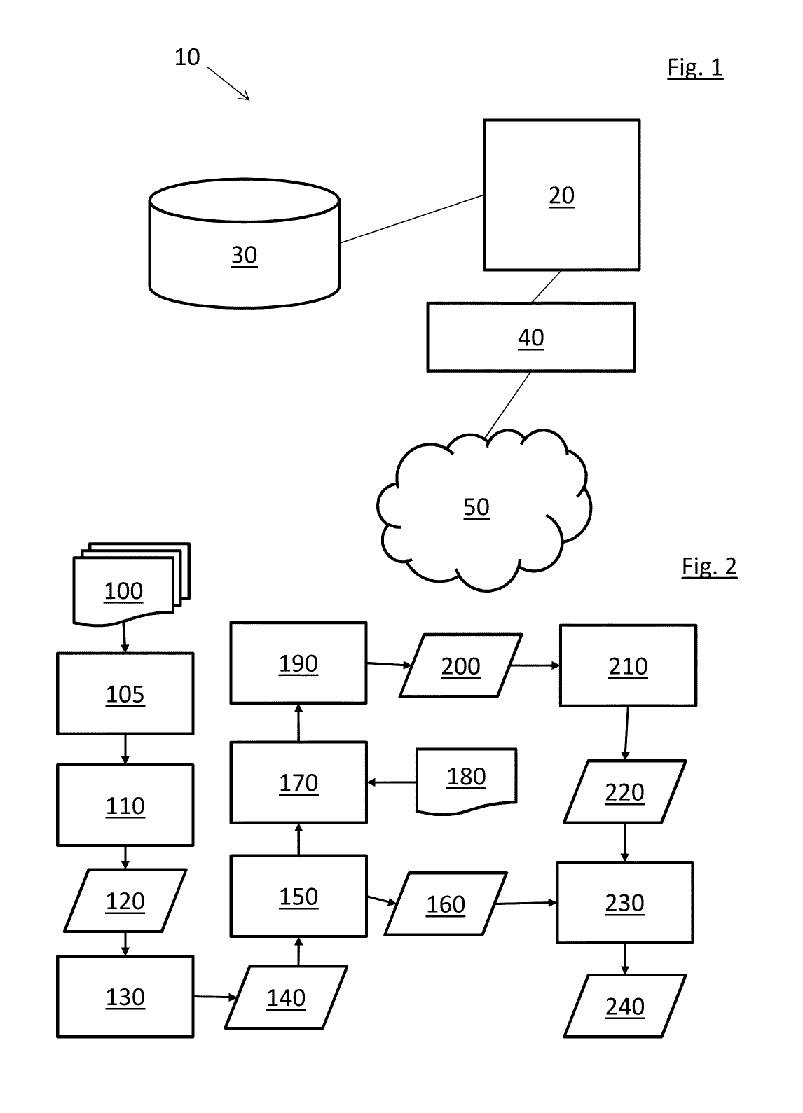

An example computer apparatus 10 (FIG. 1) for generating a measure of video quality, comprises a data processor 20, a database 30 and an interface 40 connected to the Internet 50. The database 30 contains a plurality of video data files and corresponding quality ratings 100.

In a method (FIG. 2) according to an example embodiment of the invention, a plurality of video data files and corresponding quality ratings 100 are retrieved by the processor 20 (step 105) and the processor 20 measures (step 110) a plurality of objective properties 120 of each of the video data files 100. The processor 20 calculates (step 130) for each of the video data files 100 a plurality of objective quality metrics 140 from the plurality of measured objective properties 120. The processor 20 fits (step 150) the plurality of objective quality metrics 140 to the corresponding quality rating for each of the plurality of video data files 100 and thereby obtains a set of weightings 160 for the plurality of objective quality metrics 140. The processor 20 receives (step 170) from the internet 50, via the interface 40, a target video data file 180, the quality of which is to be measured. The processor 20 measures (step 190) the plurality of objective properties 200 of the target video data file 180. The processor 20 calculates (step 210) for the target video data file 180 the plurality of objective quality metrics 220 from the plurality of measured objective properties 200 of the target video data file 180. The processor 20 generates (step 230) a measure 240 of video quality by combining the values for the objective quality metrics 220 for the target video data file 180 using the obtained set of weightings 160.

In an experiment to test the accuracy of the predictions of three example methods according to the present invention, the LIVE and the EPFL/PoliMi databases were used, providing the DMOS for several video sequences under encoding and packet-loss errors. The predictions of ten well-known metrics, ranging from mean-squared error-based criteria to sophisticated visual-quality estimators, were compared with three example embodiments of the invention.

In order to estimate the weightings, each video database was separated into two equal-size, non-overlapping, subsets: the estimation and prediction subsets, with 1≦jₑ≦Jₑ and 1≦jₚ≦Jₚ the indices within each subset and Jₑ+Jₚ=Jₜₒₜₐₗ the total number of test videos in each database. By randomly shuffling the video indexing, Tₜᵣᵢₐₗ experimental trials could be generated, with non-overlapping, estimation and prediction subsets. That reduced any bias introduced from the usage of a specific estimation and prediction subset and allowed conclusions on the efficacy of the described approach to be drawn independently of the particular video content used for training and testing.

m_{e,i,j}_{ₑ}(respectively m_{p,i,j}_{ₚ}) denotes the ith visual metric value for the jₑth (respectively jₚth) video, with the metric numbering, 1≦i≦10, following the above order and 1≦jₑ≦Jₑ (respectively 1≦jₑ≦Jₑ) the index of each video in the estimation (respectively prediction) subset of each database. The ensemble of metrics for the jₑth (respectively jₚth) video comprised the 10x1 vector m_{e,j}_{ₑ} (respectively m_{p,j}_{ₚ}). The DMOS value and standard deviation of the normalized-and-scaled difference scores for the jₑth (respectively jₚth) video are denoted by d_{e,j}_{ₑ} and s_{e,j}_{ₑ} (respectively d_{p,j}_{ₚ} and s_{p,j}_{ₚ}), and are taken from the database results.

For the tth trial, 1≦t≦Tₜᵣᵢₐₗ, each approach started from a random parameter-estimation subset of DMOS and metrics values: dₑ(t)=[d_{e,1}(t) . . . d_{e,J}_{ₑ}(t)] and Mₑ(t)=[m_{e,1}(t) . . . m_{e,J}_{ₑ}(t)]. First, a four-parameter logistic scaling function (recommended by VQEG, see Streijl, R. C. and Winkler, S. and Hands, D. S., “Perceptual Quality Measurement: Towards a More Efficient Process for Validating Objective Models [Standards in a Nutshell]”, IEEE Signal Process. Mag. (2010), 136-140 and Seshadrinathan, K. and Soundararajan, R. and Bovik, A. C. and Cormack, L. K., “Study of subjective and objective quality assessment of video”, IEEE Trans. Image Process. (2010), 1427-1441) was used for each individual metric, with non-linear fitting carried out using the estimation DMOS and metrics' values (dₑ(t) and Mₑ(t)) and the nlinfit function of Matlab. The parameters of the logistic function were kept for each trial t and used to logistically scale the corresponding metrics of the prediction subset. The 1x11 regression vector, c_{method}(t) was then estimated, with each of the example methods, in order to approximate the DMOS values of the estimation subset via

$${\hat{d}}_{e} ( t ) = [ {\hat{d}}_{e , 1} ( t ) … {\hat{d}}_{e , {J}_{e}} ( t ) ] = {c}_{method} ( t ) [ \begin{matrix}{M}_{e} ( t ) \\ 1\end{matrix} ] \qquad ( 1 )$$

with 1=[1 . . . 1] the 1xJₑ vector of ones. For each trial t, the aim of each regression method was to minimize the L_{z} norm error ∥dₑ(t)−\hat{d}ₑ(t)∥_{z}, zε{1,2}, in the estimation subset with the expectation that this will also minimize the error between the predicted DMOS \hat{d}ₚ(t)=[\hat{d}_{p,1}(t) . . . \hat{d}_{p,J}_{ₚ}(t)] and the ground-truth DMOS dₚ(t)=[d_{p,1}(t) . . . d_{p,J}_{ₚ}(t)] in the prediction subset.

In a first example method, ordinary least squares (OLS) regression (which minimizes the L₂ norm of the DMOS prediction error) was used. c_{OLS}(t) for each trial t was estimated via the estimation subset:

c_{OLS}(t)=[(Mₑ(t)[Mₑ(t)]^{T})⁻¹Mₑ(t)[dₑM]^{T}]^{T} (2)

with superscript T denoting matrix or vector transposition. Once calculated by (2), c_{OLS} (t) can be used in conjunction with the metrics for the prediction subset, Mₚ(t)=[m_{p,1}(t) . . . m_{p,J}_{ₚ}(t)], for the prediction of dₚ (t).

In a second example method, instead of minimizing the L₂ norm of the DMOS prediction error, instead the L₁ norm was minimised via L₁ regression, for example via the following iterative process:
1. The initial regression coefficients, c_{L1}⁽⁰⁾(t), were calculated via (2) and i=1 was set.
2. The 1xJₑ vector

$${w}^{( i )} = {\vert {d}_{e} ( t ) - {c}_{L 1}^{( 0 )} ( t ) [ \begin{matrix}{M}_{e} ( t ) \\ 1\end{matrix} ] \vert}^{- 1}$$

was computed
3. The updated regression coefficients were computed using (diag(w) is the diagonal matrix containing weights w):

c_{L1}⁽ⁱ⁾(t)=[(Mₑ(t)diag(w⁽ⁱ⁾)[Mₑ(t)]^{T})⁻¹Mₑ(t)diag(w⁽ⁱ⁾[dₑ(t)]^{T}]^{T} (3)
4. If ∥c_{L1}⁽ⁱ⁾(t)−c_{L1}⁽ⁱ⁻¹⁾(t)∥₂≦eₜₕᵣₑₛₕ with eₜₕᵣₑₛₕ a predetermined threshold, then stop; else, set i←i+1 and go to Step 2.
   That process is guaranteed to converge after a finite number of steps. The final coefficients, c_{L1}(t), were used in conjunction with Mₚ(t) to predict the DMOS values of the prediction subset, dₚ(t).

Alternative approaches to classical multiple linear regression models can be constructed based on a Bayesian framework. Unless based on an overly simplistic parametrization, however, exact inference in Bayesian regression models is analytically intractable. This problem can be overcome using methods for approximate inference to construct a framework for variational Bayesian linear (VBL) regression. In a third example method, OLS regression was used with a shrinkage prior on the regression coefficients. For each trial t, 1≦t≦Tₜᵣᵢₐₗ, the aim is to infer on the coefficients c_{VBL}(t) their precision α(t) and the noise precision Δ(t). Since there is no analytic expression for the posterior probability density function (PDF) p(c_{VBL}(t), α(t), λ(t)|dₑ(t)), a variational approximation of this posterior PDF is sought, starting with the product of the three marginal PDFs of c_{VBL}(t), α(t) and λ(t) and monitoring the approximation of the lower bound of log p(c_{VBL}(t), α(t), λ(t)|dₑ(t)) log p(c_{VBL}(t), a(t), l(t)|dₑ(t)) via an iterative process. Pseudocode for VBL regression is given in Algorithm 1 of Ting, Jo-Anne and D'Souza, Aaron and Yamamoto, Kenji and Yoshioka, Toshinori and Hoffman, Donna and Kakei, Shinji and Sergio, Lauren and Kalaska, John and Kawato, Mitsuo and Strick, Peter and others, “Variational Bayesian least squares: an application to brain-machine interface data”, Neural Networks (2008), 1112-1131. For our experiments, the VBL regression was realized via the TAPAS library Mathys, Christoph and Daunizeau, Jean and Friston, Karl J and Stephan, Klaas E, “A Bayesian foundation for individual learning under uncertainty”, Frontiers in human neuroscience (2011).

In the experiments, the

$${J}_{e} = {J}_{p} = \frac{{J}_{total}}{2}$$

video sequences were used for estimation and prediction (Jₜₒₜₐₗ=150 and Jₜₒₜₐₗ=144 for the LIVE and the EPFL/PoliMi databases, respectively) and Tₜᵣᵢₐₗ=400 independent trials were performed. For presentation consistency, the EPFL/PoliMi database data were scaled to the [0, 100] range employed by the LIVE database. Moreover, the standard deviation values of the EPFL/PoliMi database were derived from the reported 95% confidence intervals. The efficiency of each approach was measured via: (i) the mean absolute error of the DMOS prediction

$${M}_{method} = \frac{1}{{T}_{trial} {J}_{p}} {\sum }_{t = 1}^{{T}_{trial}} {‖ {\hat{d}}_{p} ( t ) - {d}_{p} ( t ) ‖}_{1} ;$$

(ii) the percentage of times each DMOS prediction, ∀jₚε{1,Jₚ}:\hat{d}ⱼ_{ₚ}(t), falls within [dⱼ_{ₚ}(t)−sⱼ_{ₚ}₍ₜ₎, dⱼ_{ₚ}(t)+sⱼ_{ₚ}₍ₜ₎], i.e., within one standard deviation from the corresponding experimental measurement; and (iii) the average adjusted R² correlation coefficient, which is computed over all T trial tests by

$${R}_{method}^{2} = 1 - \frac{{J}_{p} - 1}{{T}_{trial} ( {J}_{p} - {w}_{method} - 1 )} {\sum }_{t = 1}^{{T}_{trial}} \frac{{‖ {\hat{d}}_{p} ( t ) - {d}_{p} ( t ) ‖}_{2}^{2}}{{\sum }_{{J}_{p} = 1}^{{J}_{p}} {( {d}_{{j}_{p}} ( t ) - \frac{1}{{J}_{p}} {\sum }_{{J}_{p} = 1}^{{J}_{p}} {d}_{{j}_{p}} ( t ) )}^{2}} \qquad ( 4 )$$

With w_{method} being the total number of coefficients (regressors) of each model. Specifically, w_{method}=0 for each single-metric method and w_{method}=11 for all regression methods. The adjustment of R_{method}² according to w_{method} was done to take into account the use of multiple regressors and avoid spuriously increasing R_{method}² by overfitting.

Table 1 presents the results for all methods. The example methods bring 13% to 34% improvement in the mean adjusted R_{method}² value in comparison to the best of the individual metrics. By comparing OLS, L₁ and VBL regression to the best individual objective quality metrics (i.e., VQM and S-MOVIE), 9% to 19% increase is observed in the percentage of predicted DMOS values that fall within one standard deviation from the experimental DMOS values against the best individual metrics. In addition, the mean absolute error of the DMOS prediction is decreased by 27% to 35%. Even when removing the worst-performing metrics from the regression, the adjusted R_{method}² values of all three regression methods decrease between 3% to 35%; that indicates that all metrics are indeed contributing to the final DMOS prediction, albeit not to the same extent.

TABLE 1
Mean absolute error, percentage of results
within one standard deviation of the experimental DMOS
and average adjusted R_{method}² value, over
all T trial trials.

| | Database | | | | | |
|---|---|---|---|---|---|---|
| | LIVE | | | EPFL/PoliMi | | |
| | | % in | | | % in | |
| | M_{method} | 1 std | R_{method}² | M_{method} | 1 std | R_{method}² |
| Single-metric | | | | | | |
| Method | | | | | | |
| PSNR | 7.94 | 65.79 | 0.22 | 12.92 | 40.03 | 0.53 |
| SSIM | 8.03 | 65.82 | 0.19 | 15.49 | 31.81 | 0.38 |
| MS-SSIM | 6.02 | 78.43 | 0.48 | 7.88 | 59.79 | 0.83 |
| VIF | 7.97 | 66.80 | 0.18 | 14.07 | 40.01 | 0.44 |
| P-HVS | 7.38 | 70.21 | 0.32 | 10.70 | 47.37 | 0.68 |
| P-HVSM | 6.95 | 73.06 | 0.41 | 8.56 | 55.62 | 0.80 |
| S-MOVIE | 6.72 | 74.98 | 0.42 | 7.39 | 61.25 | 0.85 |
| T-MOVIE | 7.12 | 70.31 | 0.37 | 9.15 | 48.02 | 0.79 |
| MOVIE | 6.86 | 72.91 | 0.41 | 8.60 | 54.76 | 0.80 |
| VQM | 5.82 | 83.92 | 0.56 | 8.50 | 52.92 | 0.81 |
| Proposed | | | | | | |
| Method | | | | | | |
| OLS | 4.30 | 93.14 | 0.77 | 4.81 | 79.84 | 0.94 |
| L₁ | 4.26 | 93.27 | 0.77 | 5.05 | 77.31 | 0.96 |
| VBL | 4.41 | 92.63 | 0.75 | 4.81 | 79.49 | 0.94 |

To examine whether these improvements are statistically significant, F-tests (at 1% false-rejection probability) were performed between the example methods and the best single-metric methods, i.e., VQM and S-MOVIE. The related F-statistic for each trial t of each case was calculated by

$${F}_{method , metric} ( t ) = ( \frac{{J}_{p}}{{w}_{method}} - 1 ) ( \frac{{SSR}_{metric} ( t )}{{SSR}_{method} ( t )} - 1 ) ,$$

with: SSR_{metric}(t) the sum of the squared residual (SSR) error of each single-metric method at the t th experimental trial; SSR_{method} the SSR error of each regression-based method at the t th trial; and w_{method}=11 the degrees of freedom of each regression method. The “null” hypothesis of each F-test is that the DMOS prediction improvement via regression is not statistically significant, i.e., F_{method,metric}(t)≦ [symbol] ⁻¹(0.99, w_{method}, Jₚ−w_{method}), with [symbol] ⁻¹(1−a,b,c) the value of the inverse [symbol] distribution (F-threshold) at false-rejection probability a with (b,c) degrees of freedom. The results are given in Table 2.

The F_{method,metric}(t) values of the best regression methods (OLS and VBL) are higher than the threshold F-ratio for 97% to 100% of experimental trials. Therefore, the null hypothesis is rejected for more than 97% of our experiments, i.e., OLS and VBL regression lead to statistically-significant improvement against all single-metric DMOS prediction methods for the vast majority of experimental trials.

TABLE 2
Average F_{method, metric}(t) values (over all trials t)
of OLS, L₁ and VBL regression against the VQM and S-
MOVIE metrics and, in brackets, percentage of the experimental
trials that were found to be above the threshold F-ratio
at 1% false-rejection probability.

| | Database | | | |
|---|---|---|---|---|
| Method | LIVE | | EPFL/PoliMi | |
| Metric | VQM | S-MOVIE | VQM | S-MOVIE |
| OLS | 8.71 [100%] | 13.80 [100%] | 15.16 [100%] | 10.76 [97%] |
| L₁ | 8.44 [99%] | 13.43 [99%] | 12.93 [100%] | 9.14 [90%] |
| VBL | 7.90 [98%] | 12.72 [98%] | 15.18 [100%] | 10.95 [97%] |

| | | |
|---|---|---|
| F-ratio | 2.54 | 2.56 |

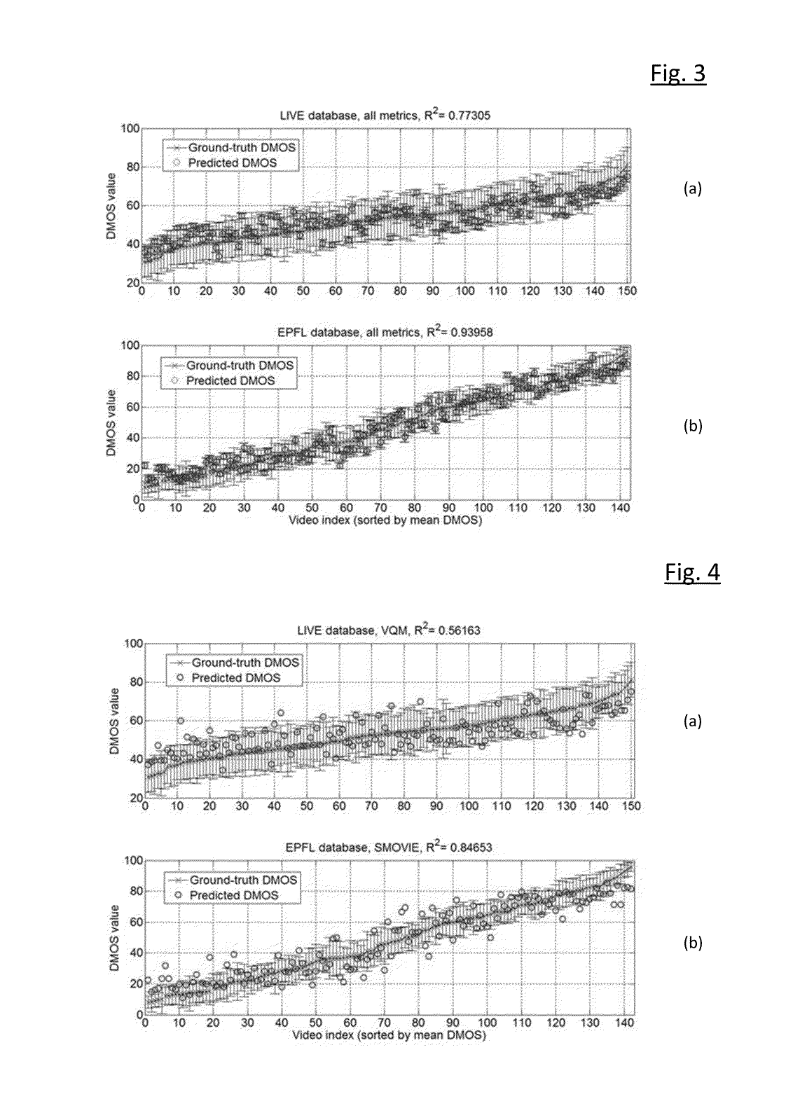

To illustrate the improvement in the DMOS prediction against the best single metrics, all video sequences were ordered by their DMOS. FIGS. 3 and 4 show: i) the ground-truth DMOS and standard deviation of difference scores of human raters; (ii) the DMOS predicted by the proposed OLS regression; (iii) the DMOS predicted by the best single-metric methods. The results are given in FIG. 3 and FIG. 4. While the S-MOVIE and VQM metrics do not predict several of the low and high DMOS values well, the proposed OLS regression provides for significantly more reliable predictions across the entire range of DMOS values.

The standard deviations in FIG. 3 and FIG. 4 illustrate the expected deviations between the experimental DMOS per video and the individual quality ratings given by each human rater to each video. It is believed that these deviations cannot be reliably predicted by any objective model. Therefore, for each experimental trial t, the optimal model, i.e., the ensemble of ground-truth human ratings, has SSR error SSRₒₚₜᵢₘₐₗ(t), that corresponds to the sum of squared residual error between individual subjective ratings and the video DMOS. Such SSR errors can also be calculated between individual subjective ratings and the best regression-based models (denoted by SSR_{model,subj}(t)).

Focusing on the EPFL/PoliMi database where the full ensemble of human ratings is publicly available, for each experimental trial t an F-test (at 1% false-rejection probability) was performed to determine whether the inventors' regression-based approaches can be deemed to be statistically equivalent to the optimal model. That is, the number of trials for which the following holds was calculated:

$$\frac{{SSR}_{model , subj} ( t )}{{SSR}_{optimal} ( t )} \leq {ℱ}^{- 1} ( 0.99 , {J}_{p} , 40 \times {J}_{p} ) ,$$

where 40 corresponds to the number of individual human raters of the database. It was found that this occurred in: (i) 35% of trials for OLS regression; (ii) 28.75% of the trials for L1 regression and (iii) 36.75% of the trials for VBL regression. However, consistent with reports of previous studies, that was not the case for any of the trials with any of the individual metrics. To the best of the inventors' knowledge, this is the first time a DMOS prediction approach exhibits statistical equivalence to the optimal (i.e. ground-truth) model for a substantial percentage of experimental trials.

The above approach views multiple high-level visual quality metrics as myopic experts, and combines them for the prediction of DMOS of video sequences. Three regression-based methods and two publicly-available databases were used for experiments. 400 experimental trials with random (non-overlapping) estimation and prediction subsets taken from both databases, show that the best of the regression methods: (i) leads to statistically-significant improvement against the best individual metrics for DMOS prediction for more than 97% of the experimental trials; (ii) is statistically-equivalent to the performance of humans rating the video quality for 36.75% of the experiments with the EPFL/PoliMi database, the optimal prediction model. This is a significant result given that no individual objective quality metrics can achieve such statistical equivalence in any test, even when its values are fitted to the entire set of DMOS values via logistic scaling.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

Envisaged example embodiments of the invention will allow media producers and online video services to measure and optimize visual quality of video services, increasing audience engagement and revenue potential.

In example embodiments of the invention, short video segments are received from an external service (e.g. the S2S transcoding service) and generation of the measure of video quality takes place automatically.

In example embodiments, a service extracts “interesting” segments of 1 to 10 seconds of transcoded videos, whereby the level of interest is assessed based on the bitrate fluctuation across time (for VBR encoding) or the PSNR/SSIM fluctuation across time for CBR encoding. Several such segments are extracted and sent to an apparatus that generates the measure of video quality.

In example embodiments, the generated video quality measures are used by the transcoding service to select transcoding options that offer better visual quality and disregard those that offer worse.

In example embodiments of the invention, the method is carried out on multiple servers in the cloud. A multitude of short video segments can then be processed in parallel. In this way, the method can be scaled to any level needed in order to handle the current volume of visual quality assessment requests.

As discussed above, content owners have many options for distribution of videos. Currently, distributors and aggregators perform their own video encoding from media provided. Example embodiments of the invention can be used to provide a benchmarking tool, for example to generate a measure of visual quality on different distribution platforms, to enable comparison and control, or to generate a measure of visual quality of incoming video, enabling content owners to perform their own encoding, avoiding the distributors' transcoding entirely. This mirrors the process in digital cinema, where a final package is produced by those who care most—the originating studio.

The viewer's Quality of Experience (QoE) is important for sustaining the revenue models (advertising or subscription-based) that enable the growth of Internet video. The QoE during video streaming depends on an array of factors: the visual quality of the streamed video, network-level metrics and user-level metrics, such as the network load, the buffering ratio, the join time, and the device type. The main challenge in developing QoE for video streaming is that the relationships between different individual metrics and user engagement are very complex. In contrast to network and user-level metrics, visual quality is a subjective metric, and so it has been more difficult to capture the actual relationship between visual quality, network conditions and QoE. Embodiments of the present invention can improve the predictive power of QoE models by providing an accurate metric of visual quality in an automated manner.

Example embodiments of the invention provide an expert crawler for transcoding optimization within a video streaming service. Transcoding optimization can be offered as a behind-the-scenes, ongoing crawler service, generating metrics and data which can be delivered into the encoding tool chain in order to continuously improve visual quality and instance selection. An illustrative example is a transcoding optimization service, i.e., providing an automated web crawler and optimization engine for media producers and publishers. Specifically, multiple transcoded versions of video content on internet servers can be ensured to be of discernible visual quality in an automated manner. This is achieved by optimizing the encoding settings such that the DMOS value predicted by the proposed invention gives diverging values for the different versions (i.e., substantially-higher predicted DMOS values should correspond to higher-bitrate versions of each video). Therefore redundant copies of video bitstreams of nearly-identical quality will be avoided. This will substantially raise the quality of online cross-platform media production services, which is well known to be one of the dominant factors for customer retention to such services [a clear correlation exists between the strength of viewer engagement in online video (e.g. avoidance of stream abandonment, fast forward, skip) and visual quality.

Modern distributed runtime environments, such as Hadoop or Openstack, provide scalable provisioning of computing resources within large datacenters (e.g. processor cores on a cloud computing system, such as Amazon EC2) to tasks that do not require real-time operation and can tolerate delay. Therefore, delay-tolerant cloud computing is a very cheap resource today, and it can be readily exploited for computationally-intensive optimization tasks. For an online video distribution service, downstream bandwidth utilization and visual quality are extremely important, and continuous optimization of these can lead to a significant competitive advantage against other offerings. Beyond such resource utilization, for a video distribution service, detecting and removing similar content (which becomes available online illegally or inadvertently) is extremely important.

One important aspect in the bandwidth provisioning of a video streaming service is the creation of appropriately-transcoded versions of the video content to ensure low, medium and high-quality streams are available to the users according to their bandwidth and device (e.g. resolution) capabilities. Example embodiments of the invention continuously mine such transcoded video collections (via a cloud-based implementation) in order to provide visual quality scores between each transcoded version and the original, but also in-between the transcoded versions themselves. For instance, consider original video Oₓ and transcoded versions T_{x,low}, T_{x,medium}, T_{x,high}, with the subscripts indicating the “low”, “medium” and “high” bitrate transcoding of video Oₓ. We can create visual scores between T_{x,low} [symbol] T_{x,medium}, T_{x,low} [symbol] T_{x,high}, T_{x,medium} [symbol] T_{x,high} as well as between Oₓ [symbol] T_{x,low}, Oₓ [symbol] T_{x,medium}, and Oₓ [symbol] T_{x,high}. Depending on whether these scores are considered to be too high or too low, an expert system makes recommendations on increasing or decreasing the bitrate of the low-, medium-, or high-bitrate transcoding of video Oₓ, in order to ensure optimal downstream bandwidth utilization and sufficient quality differentiation between the different versions. Moreover, this analysis can even be carried out in a scene-by-scene basis within the three transcodings of this example by combining the generation of the quality measure with a scene-cut detection algorithm. Given that cloud-based execution of such delay-tolerant analysis comes at a very low cost, this analysis and recommendation system can continuously crawl through new content on a large video server and, after generating the quality measure, automatically make suggestions on increasing or decreasing the bitrate of each version found. Beyond comparing transcoded versions of content, such a mechanism can also be used for device-specific characterization of loss, i.e. quality loss due to different resolution, color space and frame-rates of different end-user devices, from mobile screens to HD resolutions. This is important for video streaming services where users access content on a large variety of end-devices, from mobile handsets and tablets, to high-end displays.

Although the embodiments discussed above are designed to predict a human viewer's opinion on video quality in other example embodiments the tool (in conjunction with correlators, scene detectors and resolution detectors) can be used to assess automatically content similarity. Thus, it has been recognised that the video quality measures enabled by embodiments of the present invention, which mirror the subjective quality assessments made by human viewers, but in a repeatable and objective manner, can be used to generate a fingerprint that depends on the processing and encoding of a particular video file. Such a fingerprint can then be used to determine whether one video file is essentially a copy of another. Such a means of comparing video files can be used in controlling distribution and copying of video content. For example, such an embodiment of the invention enables the creation of automated systems to identify illicit content distributions, including the possibility of automatic issuing of take-down requests, which today requires substantial human effort.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of generating a measure of video quality, the method comprising:
(a) providing a plurality of video data files and corresponding ground-truth quality ratings expressing the opinions of human observers;
(b) measuring a plurality of objective properties of each of the video data files;
(c) calculating for each of the video data files a plurality of objective quality metrics from the plurality of measured objective properties;
(d) obtaining a set of weightings for the plurality of objective quality metrics by fitting the plurality of objective quality metrics to the corresponding ground-truth quality rating for each of the plurality of video data files;
(e) receiving a target video data file, the quality of which is to be measured;
(f) measuring the plurality of objective properties of the target video data file;
(g) calculating for the target video data file values for the plurality of objective quality metrics from the plurality of measured objective properties; and
(h) generating the measure of video quality by combining the values for the objective quality metrics for the target video data file using the obtained set of weightings.

2. A method as claimed in claim 1, in which the quality ratings are mean opinion scores, differential mean opinion scores, or quantitative scaling derived from descriptive opinions of quality.

3. A method as claimed in claim 1, in which the plurality of objective quality metrics includes at least 3 objective quality metrics.

4. A method as claimed in claim 1, in which the plurality of objective quality metrics include one or more metrics selected from the following list: a metric that is a scaled version of an objective distortion criterion; a metric that involves extraction of spatial features from an image via a frequency-selective and/or spatially-localized filter; and a metric that includes a feature extracted based on both a spatial property and a temporal property of the video sequence.

5. A method as claimed in claim 1, in which the plurality of objective quality metrics includes at least two selected from the following list: PSNR, SSIM, MS-SSIM, VIF, P-HVS, P-HVSM, S-MOVIE, T-MOVIE, MOVIE, VQM, and a combination of two or more of those metrics.

6. A method as claimed in claim 1, in which the target video data file is a file streamed over a computer network.

7. A method as claimed in claim 1, in which the fitting of the plurality of objective quality metrics to the corresponding quality rating for each of the plurality of video data files is by linear or non-linear regression.

8. A method as claimed in claim 1, including the step of obtaining a revised set of weightings for the plurality of objective quality metrics by fitting the plurality of objective quality metrics to the corresponding quality rating for each of a different plurality of video data files.

9. A method as claimed in claim 1, including the step of altering transcoding of the target video data file to alter its visual quality according to the generated measure of visual quality.

10. A method as claimed in claim 1, further including the step of automatically browsing the internet to identify target video data files, generating the measures of video quality, and altering transcoding of the target video data files to alter their visual quality according to the generated measures of visual quality.

11. A method as claimed in claim 1, including the step of generating the measure of video quality for playback of the target video file on a plurality of different end-user devices, thereby providing a device-specific characterization of video-quality loss.

12. A method as claimed in claim 1, the method may include the step of generating the measure of video quality for lower and higher quality transcodings of the same video, transmitted at lower and higher bitrates, respectively, and adjusting the bitrates to improve utilisation of bandwidth and/or to increase or decrease the difference in the generated measures of video quality for the lower and higher quality transcodings.

13. A method as claimed in claim 1, including generating a Quality of Experience rating for the video data file, the Quality of Experience rating being based on, on the one hand, the generated measure of visual quality and, on the other hand, network-level metrics and/or user-level metrics.

14. A method as claimed in claim 1, including generating the measure of video quality for a further target video data file and using the generated measures of quality in determining whether the target video file and the further target video file are identical.

15. A computer program product configured to, when run, generate a measure of video quality, by carrying out the steps:
(a) obtaining a set of weightings for a plurality of objective quality metrics, the objective quality metrics having themselves been calculated from a plurality of measurable objective properties of video data, the weightings having been determined by fitting the objective quality metrics to a set comprising a ground-truth quality rating of each of a plurality of video data files;
(b) receiving a target video data file, the quality of which is to be measured;
(c) calculating values for the objective quality metrics on the target video data file; and
(d) generating the measure of video quality by combining the values for the objective quality metrics on the target video data file using the obtained set of weightings.

16. A computer apparatus for generating a measure of video quality, the apparatus comprising:
(a) a memory containing a set of weightings for a plurality of objective quality metrics calculated from a plurality of measurable objective properties of video data;
(b) an interface for receiving a target video data file; and
(c) a processor configured to (i) calculate values for the objective quality metrics on a received target video data file, (ii) retrieve the set of weightings from the memory and (iii) generate the measure of video quality by combining the values for the objective quality metrics on the received target video data file using the retrieved set of weightings.
